(19) United States
(12) Patent Application Publication
(10) Pub. No.: US 2005/0021644 A1
(43) Pub. Date: Jan. 27, 2005

(54) Systems and methods for validating electronic communications

(76) Inventor: Glenn Hancock, Jackson, GA (US)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(21) Appl. No.: 10/856,410

(22) Filed: May 28, 2004

Related U.S. Application Data
(60) Provisional application No. 60/473,819, filed on May 28, 2003.

(51) Int. Cl. G06F 15/16

(52) U.S. Cl. 709/206

(57) ABSTRACT

Example systems, software, methods, computer-readable media and so on associated with validating electronic communications are provided. In one embodiment, a system includes a retrieval logic configured to obtain sender attributes from an electronic communication, and a validation logic configured to query a registration network and produce a validation signal.

### CROSS REFERENCE TO RELATED APPLICATIONS

This application claims priority to provisional application No. 60/473,819, filed May 28, 2003, the contents of which is herein incorporated by reference.

### BACKGROUND

Electronic communications, e-mail for example, have become a popular way of communicating. Although many electronic communications received by a user or recipient are desired, expected or requested, other communications may be unrequested or unwanted. Such unrequested electronic communications in the form of e-mail may be called, for example, “spam,” “ray mail,” “unsolicited commercial e-mail” (UCE), “unsolicited bulk e-mail” (UBE) and the like. Spam may be used to advertise products, broadcast political or social commentary, and the like. The individuals, organizations or other entities sending spam may be called “spammers.” Spammers may send millions of e-mail messages within short periods of time (e.g., hours). These communications may be a nuisance to users who receive them.

Spam may utilize the resources of a user's electronic device for receiving e-mail, such as computers, personal digital assistants (PDA's), cellular telephones and the like. Such resource utilization may prevent receipt of desired e-mail. Additionally, spam messages may cause problems for Internet Service Providers (ISP's). For example, spam messages may drain the ISP's bandwidth, utilize data storage capacity and/or increase the need for human capital to deal with the spam.

A variety of systems and methods for preventing the nuisances caused by spam have been devised. Some of these systems and methods relate to “filtering” or “blocking” of e-mail. In one example, an ISP may configure an e-mail server, or an individual may configure an electronic device for receiving electronic messages, to screen incoming messages for those originating from electronic addresses of known spammers. Messages identified as sent from spammers may be prevented from reaching a user or being viewed by a user. In another example, e-mail servers or electronic devices may be configured to screen the subject line header or body text of incoming messages for keywords indicating the e-mail message was sent by a spammer. In another example, a user's electronic device may contain a database of addresses of senders from whom the user wishes to receive electronic communications. Messages from such addresses may be permitted to reach the user. Other messages may not be permitted to reach the user. Many of the existing systems and methods for filtering and/or blocking spam e-mail messages may be ineffective, for a variety of reasons.

### BRIEF DESCRIPTION OF THE DRAWINGS

In the accompanying drawings, which are incorporated in and constitute a part of the specification, embodiments are illustrated which, together with the detailed description given below, serve to describe the example embodiments. It will be appreciated that the embodiments illustrated in the drawings are shown for the purpose of illustration and not for limitation. It will be appreciated that the Figures are not drawn to scale and that selected components within any Figure may be illustrated in enlarged or reduced form without comment to improve clarity and understanding of particular concepts being discussed. Any shading used in the Figures is to improve clarity of elements or components for discussion. Shading is not intended to suggest any particular characteristics or attributes. It will be appreciated that changes, modifications and deviations from the embodiments illustrated in the drawings may be made without departing from the spirit and scope of the invention, as disclosed below. It will be appreciated that illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

FIG. 1 illustrates an example system 100 for validating electronic communications;

FIG. 2 illustrates an example implementation of a system 200 for validating electronic communications;

FIG. 3 illustrates another example implementation of a system 300 for validating electronic communications;

FIG. 4 illustrates another example implementation of a system 400 for validating electronic communications;

FIG. 5 illustrates an example of process steps within a registration network 500 when being queried by a validation logic of a system for validating electronic communications;

FIG. 6 illustrates an example method 600 for validating electronic communications;

FIG. 7 illustrates an example method 700 for preparing a registration network; and

FIG. 8 illustrates an example computer 800 that contains a retrieval logic 825 and validation logic 830.

### DETAILED DESCRIPTION

The following includes definitions of selected terms used throughout the disclosure. The definitions include examples of various embodiments and/or forms of components that fall within the scope of a term and that may be used for implementation. The examples are not intended to be limiting and other embodiments may be implemented. Both singular and plural forms of all terms fall within each meaning.

As used in this application, the term “computer component” refers to a computer-related entity, either hardware, firmware, software, a combination thereof, or software in execution. For example, a computer component can be, but is not limited to being, a process running on a processor, a processor, an object, an executable, a thread of execution, a program, and a computer. By way of illustration, both an application running on a server and the server can be computer components. One or more computer components can reside within a process and/or thread of execution and a computer component can be localized on one computer and/or distributed between two or more computers.

“Address”, as used herein, includes but is not limited to one or more communication network accessible addresses, device identifiers, IP addresses, e-mail addresses, a distribution list including one or more e-mail addresses, url and ftp locations or the like, network drive locations, a postal address, or other types of addresses that can identify a desired destination or device.

“Computer communication”, as used herein, refers to a communication between two or more computing devices (e.g., computer, personal digital assistant, cellular telephone) and can be, for example, a network transfer, a file transfer, an applet transfer, an email, a hypertext transfer protocol (HTTP) transfer, and so on. A computer communication can occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and so on.

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of electromagnetic radiation, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or card, a carrier wave/pulse, or any other medium from which a computer, a processor or other electronic device can read. Signals used to propagate instructions or other software over a network, such as the Internet, or other transmission medium are also considered a “computer-readable medium.”

“Data Structure”, as used herein, refers to the way in which data is stored. Data may be stored in one or more data structures. The data structure may be embodied as one or more databases, tables, text files, linked lists, arrays, trees, or other desired data structure configured to store information. The data structure may also include one or more indices, hash functions, relational components, or other mechanisms that assist in accessing the data structure if desired. The data structure, in one embodiment, may be embodied in a computer-readable medium.

“Data store”, as used herein, refers to a physical and/or logical entity that can store data. A data store may be, for example, a database, a table, a file, a list, a queue, a heap, a memory, a register, and so on. A data store may reside in one logical and/or physical entity and/or may be distributed between two or more logical and/or physical entities.

“Internet”, as used herein, includes a wide area data communications network, typically accessible by any user having appropriate software.

“Intranet”, as used herein, includes a data communications network similar to an internet but typically having access restricted to a specific group of individuals, organizations, or computers.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like an application specific integrated circuit (ASIC), an analog circuit, a digital circuit, a programmed logic device, a memory device containing instructions, or the like. Logic may include one or more gates, combinations of gates, or other circuit components. Logic may also be fully embodied as software. Where multiple logical logics are described, it may be possible to incorporate the multiple logical logics into one physical logic. Similarly, where a single logical logic is described, it may be possible to distribute that single logical logic between multiple physical logics.

“Network”, as used herein, includes but is not limited to the internet, intranets, Wide Area Networks (WANs), Local Area Networks (LANs), and transducer links such as those using Modulator-Demodulators (modems). A network may include or contain one or more data stores.

Network Communication Protocol Examples: Communication between a client computer and a server may take place using one of several network protocols, such as hypertext transfer protocol (HTTP), file transfer protocol (FTP), Common Internet File System (CIFS) protocol, Gopher, other available protocol, or a custom protocol.

An “operable connection”, or a connection by which entities are “operably connected”, is one in which signals, physical communications, and/or logical communications may be sent and/or received. Typically, an operable connection includes a physical interface, an electrical interface, and/or a data interface, but it is to be noted that an operable connection may include differing combinations of these or other types of connections sufficient to allow operable control. For example, two entities can be operably connected by being able to communicate signals to each other directly or through one or more intermediate entities like a processor, operating system, a logic, software, or other entity. Logical and/or physical communication channels can be used to create an operable connection. For example, device that are part of a network can be said to be operably connected.

“Server”, as used herein, includes but is not limited to an entity that can be accessed by another entity. An entity may be one or more electronic devices, such as one or more computers. Typically, a server is accessed for the purpose of obtaining data from the server, entering data onto the server, and the like. A server may be a computer system used by users to store their e-mail messages until they retrieve them. ISP's, Corporate Administrators, and the like may use these servers. One example server is an “e-mail server.”

“Signal”, as used herein, includes but is not limited to one or more electrical or optical signals, analog or digital signals, data, one or more computer or processor instructions, messages, a bit or bit stream, or other means that can be received, transmitted and/or detected.

“Software”, as used herein, includes but is not limited to, one or more computer or processor instructions that can be read, interpreted, compiled, and/or executed and that cause a computer, processor, or other electronic device to perform functions, actions and/or behave in a desired manner. The instructions may be embodied in various forms like routines, algorithms, modules, methods, threads, and/or programs including separate applications or code from dynamically linked libraries. Software may also be implemented in a variety of executable and/or loadable forms including, but not limited to, a stand-alone program, a function call (local and/or remote), a servelet, an applet, instructions stored in a memory, part of an operating system or other types of executable instructions. It will be appreciated by one of ordinary skill in the art that the form of software may be dependent on, for example, requirements of a desired application, the environment in which it runs, and/or the desires of a designer/programmer or the like. It will also be appreciated that computer-readable and/or executable instructions can be located in one logic and/or distributed between two or more communicating, co-operating, and/or parallel processing logics and thus can be loaded and/or executed in serial, parallel, massively parallel and other manners.

Suitable software for implementing the various components of the example systems and methods described herein include programming languages and tools like Java, Pascal, C#, C++, C, CGI, Perl, SQL, APIs, SDKs, assembly, firmware, microcode, and/or other languages and tools. Software, whether an entire system or a component of a system, may be embodied as an article of manufacture and maintained or provided as part of a computer-readable medium as defined previously. Another form of the software may include signals that transmit program code of the software to a recipient over a network or other communication medium. Thus, in one example, a computer-readable medium has a form of signals that represent the software/firmware as it is downloaded from a web server to a user. In another example, the computer-readable medium has a form of the software/firmware as it is maintained on the web server. Other forms may also be used.

“Query”, as used herein, refers to a semantic construction that facilitates gathering and processing information. A query might be formulated in a database query language like structured query language (SQL) or object query language (OQL). A query might be implemented in computer code (e.g., C#, C++, Javascript) that can be employed to gather information from various data stores and/or information sources.

“User”, as used herein, includes but is not limited to one or more persons, software, computers or other devices, or combinations of these.

Some portions of the detailed descriptions that follow may be presented in terms of algorithms and symbolic representations of operations on data bits within a memory. These algorithmic descriptions and representations are the means used by those skilled in the art to convey the substance of their work to others. An algorithm is here, and generally, conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic and the like.

It has proven convenient at times, principally for reasons of common usage, to refer to these signals as bits, values, elements, symbols, characters, terms, numbers, or the like. It should be borne in mind, however, that these and similar terms are to be associated with the appropriate physical quantities and are merely convenient labels applied to these quantities. Unless specifically stated otherwise, it is appreciated that throughout the description, terms like processing, computing, calculating, determining, displaying, or the like, refer to actions and processes of a computer system, logic, processor, or similar electronic device that manipulates and transforms data represented as physical (electronic) quantities.

This application describes example systems, software, methods, computer-readable media and the like associated with validating electronic communications. The example systems and the like generally provide for validating the address from which an electronic communication, such as an e-mail message, is sent or originates, or is purportedly sent or purportedly originates. Spammers may remove and/or replace the origination address with an invalid or false address (e.g., spoofing). Such addresses are generally found in the header of an e-mail message. Spammers may also transmit an electronic communication through various servers, such that the message contains the header address of a server other than the server from which the e-mail originated (e.g., relaying). Such addresses do not accurately indicate the origin of the electronic communication. Generally, such addresses can be said to be “invalid” because they are not addresses where the sender of the message can receive and/or respond to a message that is sent to the address.

The example systems and the like provide for determining the validity of the header address of an e-mail message using a registration network that contains valid e-mail addresses (e.g., e-mail addresses to which an e-mail could be sent and received by a user). In one embodiment, the registration network contains valid e-mail addresses representing, identifying or related to every known user on the Internet. Validation of an address from an incoming e-mail against the addresses in the registration network (e.g., presence of the address from an incoming e-mail on the registration network) generally permits a user to receive and/or view the e-mail, thereby producing a positive validation signal. Lack of validation of an address (e.g., the address from an incoming e-mail is not present in the registration network or, if the address is present in the registration network, it is designated as an invalid address, an address of a spammer, and so on) generally produces a negative validation signal and does not permit a user to receive and/or view the e-mail. Generally, the registration network does not contain e-mail addresses of spammers or, if such e-mail addresses are contained therein, they may not produce a positive validation signal. Users may choose to be protected by such a validation system. Such protected users may not be able to access or view e-mail messages that do not originate from valid e-mail addresses.

The example registration network may be a central server that can be accessed any servers that receive e-mail. The system for validating e-mail addresses may provide for any e-mail server to access the registration network to determine, for example, an e-mail message sent to a user is a valid e-mail address. The example registration network, therefore, is a central network that contains e-mail addresses that can be accessed by many systems. The designation associated with an e-mail address in the registration network, for example whether the address is valid or is not valid, is a single source that can be accessed by many users.

In one embodiment, the example systems, may provide a retrieval logic and a validation logic. The retrieval logic may be configured to obtain sender attributes from an electronic communication sent to a user or recipient. One example of an electronic communication is an e-mail message. The sender attributes may include one or more e-mail addresses from which the message was sent or purportedly sent.

The validation logic may be configured to query one or more registration networks and produce a validation signal. The registration networks generally contain e-mail addresses identifying individuals and/or organizations who are not spammers. The query performed by the validation logic may include comparing the sender attributes from a message sent to a user to the e-mail addresses in the registration network. The validation signal may include the result of the comparison. The validation signal may be used to determine whether or not the electronic communication is an unwanted communication, such as one sent by a spammer for example. The validation signal may be used to determine whether the electronic communication is permitted to reach the intended recipient or user and/or whether the user can view the message.

System for Validating Electronic Communications

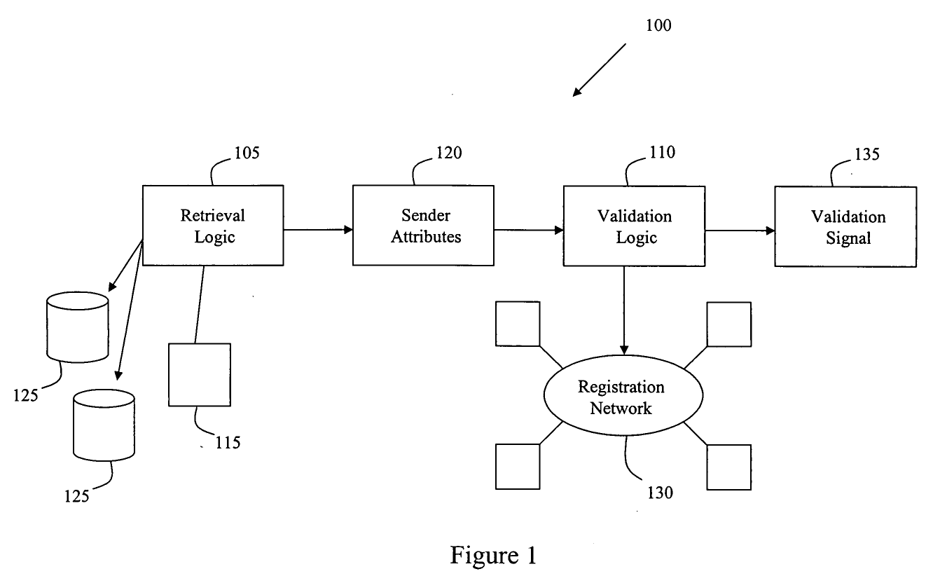

Illustrated in FIG. 1 is an example system 100 for validating electronic communications. The example system 100 may include a retrieval logic 105 and a validation logic 110. The retrieval logic 105 may be configured to examine and obtain sender attributes 120 from an electronic communication 115 that is sent to a user. The electronic communication 115 may be located in one or more locations in one or more data stores 125. For example, the electronic communications 115 may be located on one or more computers, servers, hard drives, computer networks and the like.

Herein, “sender attributes” 120, refers to information from or related to the electronic communication 115. Generally, the sender attributes 120 include information as to the origin or purported origin of the electronic message 115 (e.g., an address from which the electronic message was sent or purportedly sent). In the instance where the electronic communication 115 is an e-mail message, the sender attributes 120 may be the e-mail address of the sender of the e-mail, or the purported e-mail address of the sender or purported sender of the e-mail. The address may generally be found in the e-header of the e-mail message.

With further reference to FIG. 1, the validation logic 110 may be configured to query one or more registration networks 130 and produce a validation signal 135. The registration network 130 may include one or more data stores. As discussed above, and as discussed in more detail below, the registration network 130 can generally include “valid” e-mail addresses. Valid e-mail addresses are generally those addresses found in the header of a first e-mail message sent by a first user to a second user, where a return e-mail message from the second user to the header address is receivable by the first user. E-mail addresses that purportedly identify the senders of spam e-mails often are not valid e-mail addresses. Many such addresses are either fictitious or do not identify the individual or organization who sent the e-mail. As will be discussed in more detail below, even if a spammer has a valid e-mail address, the example registration network 130 described herein generally may be designed to prevent or eliminate the inclusion of such e-mail addresses.

In one example, the validation logic 110 queries the registration network 130 using sender attributes 120, which may include the e-mail address from which the electronic message 115 was sent or purportedly sent. In one example query, the validation logic 110 may ask whether an e-mail address included in the sender attributes 120 is present in the registration network 130 and/or if it is a valid address. The validation signal 135 may include the result of this query. For example, the validation signal 135 may include information indicating that the e-mail address of the sender attributes 120 is a valid address. In this case, a positive validation signal may be produced. In another example, the validation signal 135 may include information indicating that the e-mail address of the sender attributes 120 is not a valid address. In this case, a negative validation signal may be produced. The validation signal 135 may indicate whether or not the electronic communication 115 sent to the user was sent by a spammer. The validation signal 135 may be used to determine whether an e-mail message sent to a user reaches and/or is viewable by a user.

In one example, if a user has elected to be protected by the system, the registration network would commence validation of messages sent to the protected user account. If the system detects that the e-mail originated from an unregistered email account (e.g., an e-mail address that is not valid), a validation signal to the e-mail server would indicate that the message should not be delivered to the intended recipient and, thus the e-mail may be intercepted and discarded by the e-mail server. During this interception, the system may log the address of the e-mail originator as well as when it was sent to the user's account.

As is discussed in more detail later, the system may also send an e-mail registration request to the sender of an invalid e-mail message, in order to allow the sender to register themselves by replying to the e-mail registration request. Once registered, the sender may immediately resend the e-mail. At any time, the protected user may be able to review e-mails that were blocked by the system by reviewing their account on the website of the service. This service may provide the ability to view who e-mail was sent from.

It is to be appreciated that the registration network may be accessible by any number of e-mail servers, for example. In one instance, an e-mail address that is included in the registration network and is a valid address, may be accessed and give rise to a similar validation signal for different users who may access their e-mail messages through different e-mail servers or through different ISP's.

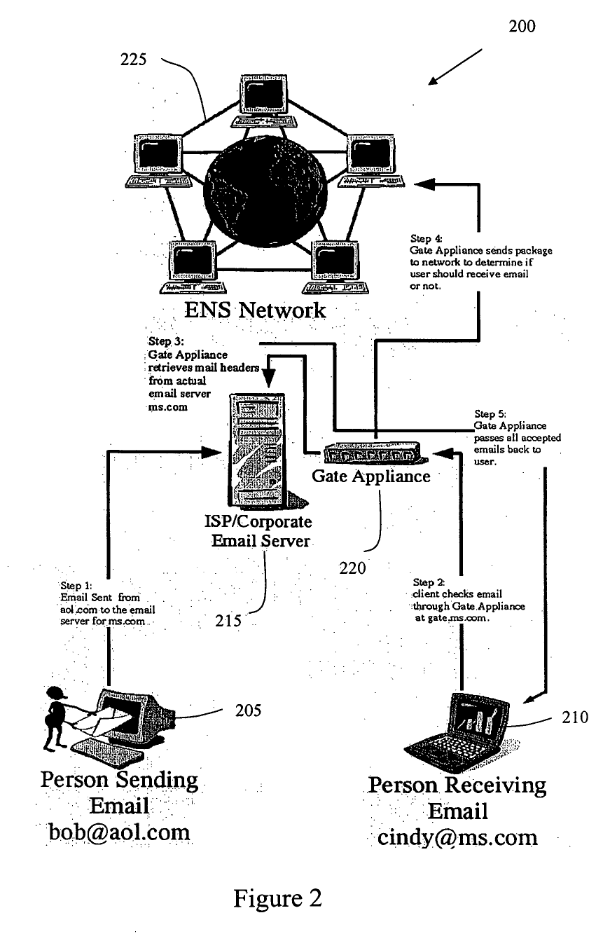

Illustrated in FIG. 2 is an example implementation of a system 200 for validating electronic communications. In the illustration, an e-mail message is sent by an example sender, here represented by a computer 215, having an address “bob@aol.com,” to an example user, also represented by a computer 210, having an address “cindy@ms.com.” When dispatched by the sender to the user, the e-mail message may be transmitted to one or more servers, for example an e-mail server 215. In order to access the e-mail message, the user may access the server through an electronic device for receiving e-mail, such as the illustrated computer 210. When the user wishes to check whether any e-mail messages have been sent to the user, the user goes to the electronic device 210 and may query the server 215 on which e-mail messages sent to the user may reside.

As shown in the figure, the query by the computer 210 to the server 215 is first received by a gate appliance or gateway appliance 220. In this example, the gateway appliance 220 embodies a retrieval logic and a validation logic. The retrieval logic may obtain sender attributes from the e-mail messages present on the server 215 that have been sent to the user. The sender attributes may include header information from the e-mail messages sent to the user. In this particular example, the sender attributes include the e-mail address, “bob@aol.com.”

The validation logic embodied in the gateway appliance 220 may query a registration network 225. In this particular example, the registration network 225 is called an “e-mail name server” or “ENS.” The registration network 225 would typically contain e-mail addresses that are known to be valid. Generally, the e-mail addresses contained on or in the registration network 225 are addresses of persons or organizations from whom desired, expected or solicited e-mail messages may have been sent. In one embodiment, the e-mail addresses present on the registration network 225 are of persons and/or organizations that are not spammers. The query of the registration network 225 by the validation logic may involve determining whether the sender attributes, here including bob@aol.com, are present on the registration network 225 and/or are indicated thereon as a valid address.

The query of the registration network 225 by the validation logic generally produces a validation signal. The validation signal may include the result of the query of the registration network 225 by the validation logic. In this particular example, the validation signal may include information as to whether the bob@aol.com address is present on the registration network 225 and/or is a valid address. The validation signal may also contain information that determines whether e-mail messages on the server 215 are to be transmitted to the user's computer 210 so they can be read by the user. The determination of whether the messages on the server 210 are to be made available to the user may depend on the results of the query of the registration network 225 by the validation logic, as embodied in the validation signal. In the illustrated example, if the bob@aol.com address is present on the registration network 225, the validation signal may include information that permits the particular e-mail message to be transmitted to the user (e.g., a positive validation signal), cindy@ms.com, through the illustrated computer 210. If the bob@aol.com address is not present on the registration network 225, the validation signal may include information that does not permit the particular e-mail message to be transmitted to the user (e.g., a negative validation signal). In the latter case, the e-mail message may be destroyed or the e-mail message may be returned to the sender's e-mail address with an invitation to add the address to the registration network 225.

In another example, e-mail messages for which a negative validation signal has been produced may be presented to the user in the form of a “blocklist.” A blocklist lists for the user e-mail messages that have been blocked by the system. In another example, in order to cut down on the size of the blocklists, a service that monitors sending of verification e-mails by the registration network is provided. This monitoring includes those e-mail addresses on the blocklist for which it was possible to send verification e-mails. This service works under SMTP protocol parameters that if an e-mail message is attempted to be handed off to an e-mail server, the user attributes are verified before it will be allowed. Performing this monitoring step provides for eliminating questionable e-mail messages immediately and removing them from the user's blocklist and from the user's received e-mail message box, decreasing the amount of storage space required to hold the message on a mail server. Once an e-mail address is determined to be invalid, it is added to a global blacklist which prevents further examination of the e-mail address by other users and blocks the e-mail message when it arrives. In another example, a module is provided that finds and blocks open relay e-mail servers. This module provides for monitoring of incoming IP addresses for e-mail messages that pass through it and, if any are determined to allow relaying, the IP address is blocked.

It should be appreciated that the action by the retrieval logic to obtain sender attributes from an electronic communication, and/or the query of the registration network by the validation logic, may be initiated by a variety of different signals. In one example, one or both of these actions may be initiated by a user who wishes to check for e-mail messages and goes to an electronic device which may query the server on which e-mail messages may reside. In another example, actions by one or both of the retrieval logic and validation logic may be initiated by receipt of an e-mail message by the server. In another example, actions by one or both of the retrieval logic and validation logic may be initiated before an e-mail message is received by a server. In this latter case, a positive validation signal may be required to permit the e-mail message to reside on the server, as is discussed below. In other examples, there may be other signals that cause the retrieval logic and/or validation logic to begin their activities

It should also be appreciated that the system for validating electronic communications may be implemented at any of various points in a network. FIG. 2, for example, illustrates an embodiment of the system where e-mail messages from which sender attributes are obtained are present on an e-mail server 215. In other embodiments of the system, the events that lead to a validation signal may be performed on an e-mail message before the message is permitted to be received by a particular server.

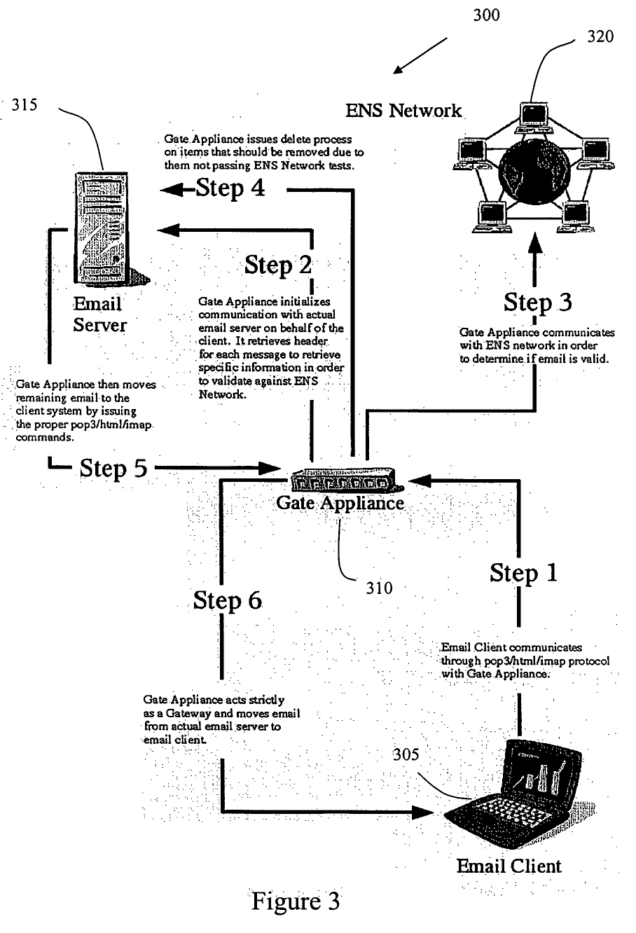

Illustrated in FIG. 3 is another example implementation of a system 300 for validating electronic communications. In this example, a user wishing to check for e-mail messages sent to the user, may use an e-mail client 305 to communicate with a gate appliance 310. In this particular example, the gate appliance 310 may embody both a retrieval logic and a validation logic. The retrieval logic may retrieve header information from a message sent to the user. The messages from which the header information is retrieved may be located on one or more e-mail servers 315. The header information may be used by the validation logic to communicate with an ENS Network 320 that may contain a listing of valid e-mail addresses. Based on the result or results of the query, a validation signal may be produced. The validation signal may contain information that directs the e-mail to be deleted from the server 315. In this case, the message is not available to the user to download to the e-mail client 305 and/or for viewing. Generally, this occurs if the header information, which includes the e-mail address from which the message was sent or purportedly sent, is not found on the ENS Network 320. Alternatively, the validation signal may include information that permits the user to access and/or view the e-mail message. In this case, the validation signal may direct the e-mail message to be transmitted from the server 315 to the e-mail client 305.

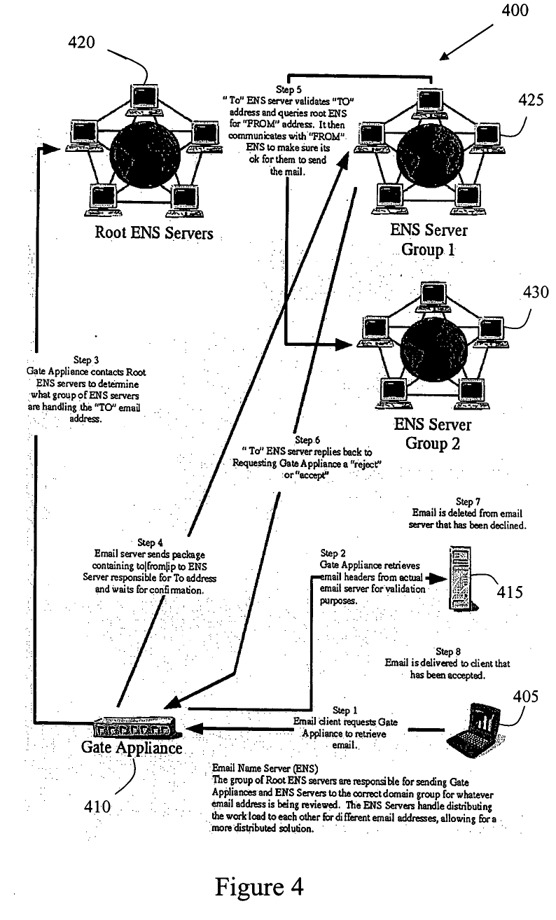

FIG. 4 illustrates implementation of another example system 400 for validating electronic communications. In this example, a user may use a client 405 to request e-mail messages that have been sent to the user. The request is made through a gate appliance 410. In this example, the gate appliance 410 embodies a retrieval logic and a validation logic. The retrieval logic obtains sender attributes from messages sent to the user. In this example, the messages are located on a server 415. Once obtained, the validation logic of the gate appliance 410 may send a query to a registration network. In this example, the registration network is comprised of two networks. One network may be called an “index network.” In this example, the index network is indicated as “Root ENS” servers 420. The other network may be the “validation network.” In this example, the validation network is indicated as “ENS Servers.” The validation network may be comprised of multiple domains, as is discussed below. Also, different processes performed by a validation network may be divided between different servers, for example. In the illustrated example, the server indicated as ENS server group 1 425 processes the “TO” address of the sender attributes. In the illustrated example, the server indicated as ENS server group 2 430 processes the “FROM” address of the sender attributes.

The index network may not contain information pertaining to an e-mail address that can lead to a validation signal (e.g., whether the e-mail address is valid). Index networks may track e-mail addresses associated with a registration network. Information pertaining to an e-mail address that can lead to a validation signal may be contained in the validation network. Such information for a given e-mail address may not be present in all domains of the validation network. Such information for a given e-mail address may be present on only a few or even on a single domain of the validation network. The index network may contain information as to which domain or domains of the validation network contain information for a given e-mail address that can lead to a validation signal.

With further reference to FIG. 4, once the retrieval logic obtains e-mail header addresses from messages sent to the user, the query sent by the validation logic of the gate appliance 410 to the registration network is sent to the index network portion of the registration network, here illustrated as Root ENS servers 420. In response to the query, the gate appliance 410 receives information as to which domain or domains of the validation network contain information for the given e-mail address that can lead to a validation signal. The validation logic then queries this domain of the validation network and a validation signal is obtained by the gate appliance 410. The validation signal may be used to delete the e-mail from the server 415 (e.g., a negative validation signal). The validation signal (e.g., a positive validation signal) may be used to transmit the e-mail to the client 405.

Registration Networks

As used herein, registration networks may include addresses from which electronic communications have been sent or purportedly sent. In one example, the addresses included in a registration network are e-mail addresses. The addresses may be valid addresses. In one embodiment, the registration network may include every valid e-mail address that is known. In other embodiments, the registration network may include one or more subsets of known valid e-mail address. The e-mail addresses may identify or be associated with persons, organizations and the like, who are not spammers. Spammers generally do not send e-mail messages with valid return addresses.

Information related to e-mail addresses, other than validity of the address, may also be included in the registration network. In one example, an e-mail address included in a registration network may be associated with the name of the person, organization or other entity that added the address to the registration network. Addition of e-mail addresses to a registration network is described in more detail below. In another example, an e-mail address included in a registration network may be associated with the date when the address was validated. Validation, also called processing or registration, of an e-mail address is discussed in more detail below. In another example, an e-mail address included in a registration network may be associated with information relating to whether or not a particular user desires to receive e-mail from the particular address. In another example, an e-mail address may be associated with information relating to the number of times a validation logic has queried the particular address. In another example, an e-mail address may be associated with information relating to the number of messages sent from the particular address in a period of time. A variety of other information may be associated with one or more e-mail addresses included in a registration network.

It is to be appreciated that the registration network, the addresses included in the registration network and the information associated with e-mail addresses included in the registration network are configured to be accessed and/or queried by one or more systems for validating electronic communications. In one example, the access and/or query is performed by a validation logic. The registration network may be a central repository for e-mail addresses that may be accessed by numerous systems for validating e-mail messages. In one embodiment, each e-mail server or ISP may have a system containing a retrieval logic and a validation logic that can access the central registration network.

The registration network may be embodied in one or more data stores. The data stores may include one or more databases. The databases may be maintained on a bank of servers located and synchronized between multiple datacenters. The registration network may include multiple networks. In one example, a registration network may include one or more index networks and one or more validation networks. The registration network may include more than one domain. The registration network may also be comprised of separate networks, each separate network performing a different function, that may be performed in response to a query by a validation logic for example.

Generally, e-mail addresses are added to the registration network. It is anticipated that e-mail addresses can be added to the registration network in a variety of ways. In one example, an individual user may contribute the user's own e-mail address to the registration network. In another example, an ISP or other company or group that hosts addresses may add or contribute one or more e-mail addresses to the registration network. In the latter example, a secure login to the registration network may be provided, for example, on a Secure Socket Layer (SSL) connection. It will be appreciated that there may be other methods by which e-mail addresses can be added to the registration network.

E-mail addresses that are added to the registration network generally are processed. In one example, processing may include querying the registration network to determine whether the address is already present in the registration network. In another example, processing may include a determination as to whether an e-mail address added to the registration network is valid. A valid address that is included in the registration network may be said to be a “registered” address.

Processing an e-mail address to determine if such e-mail address is valid may include sending one or more e-mail messages to the e-mail address that has been added to the registration network. The recipient of the e-mail message may be required to respond to the message in order for that particular e-mail address to become or remain registered. Such e-mail messages may contain a unique code that is transmitted back to the registration network when the recipient of the e-mail message responds to the message, which will be discussed in further detail below. Presence of the code may be required for the responsive e-mail message to register the e-mail address upon transmission back to the registration network.

In one example, the response to the message sent to the e-mail address that had been added to the registration network, may be by return e-mail as described above. In other examples, a response may take the form of clicking within a link in the e-mail message sent to the address added to the registration network. The click may be transmitted back to the registration network and may indicate that the particular e-mail address is valid and attended by a recipient. In other examples, responses may take other forms, but generally require the recipient of the e-mail to communicate with the registration network in order to demonstrate the validity of the e-mail address.

It is to be appreciated that generally, once an e-mail address has been registered, e-mail messages sent from the registered address may be received by all users who have chosen to be protected from unrequested e-mail messages by the system for validating e-mail messages described herein. In one embodiment, an e-mail address that has been added to the registration network and has been processed to determine if it is valid, is generally able to originate or send e-mail messages to all protected users, not just the user responsible for processing the address to determine if it is valid. Generally, once an e-mail address has been registered, messages sent from the address are received by users protected by the system without the registration network sending an additional e-mail messages that requre responses thereto.

In another embodiment, the registration network may periodically query an e-mail address that is added to or included in the registration network, for example by sending one or more periodic e-mail messages to the address and requiring a response, as described above.

Although spammers generally do not send e-mail messages with valid return addresses, it will be appreciated that spam may occasionally be sent from valid e-mail addresses. To prevent unrequested e-mail messages from such addresses from reaching users that are protected by the system, the registration network may include information related to the number of e-mails sent from e-mail addresses included in the registration network. For example, the registration network may include a logic configured to ascertain the number of e-mails sent from e-mail addresses included in the registration network. In another example, the registration network may have a logic configured to ascertain the number of queries one or more validation logics make to the registration network in relation to a given e-mail address. The registration network may have the ability, for example, to de-register an e-mail address if a large number of e-mail messages were sent from an address during a period of time. In such an example, a valid e-mail address may be unable to give rise to a positive validation signal. In another example, the registration network may have the ability to impose limits on the number of e-mail messages that are sent from a given e-mail address in a period of time or that can be received by a user that is protected by the validation system. Because spammers may send millions of e-mails in an hour, such limits may prevent spammers from infiltrating the system.

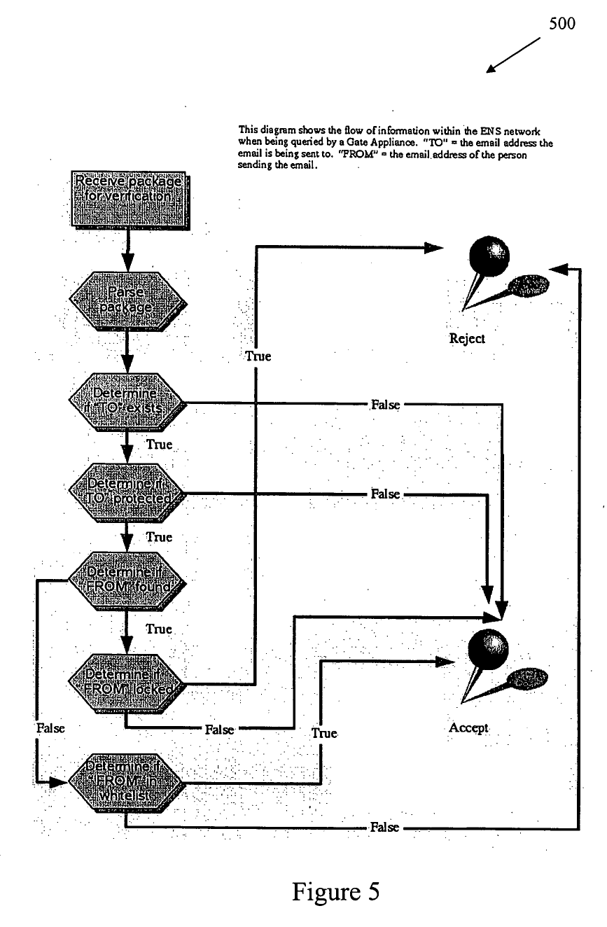

FIG. 5 illustrates an example of process steps within the registration network 500 when being queried by a validation logic of a system for validating electronic communications. The “TO” and “FROM” references in the figure refer to e-mail addresses in the header of an e-mail sent to a user.

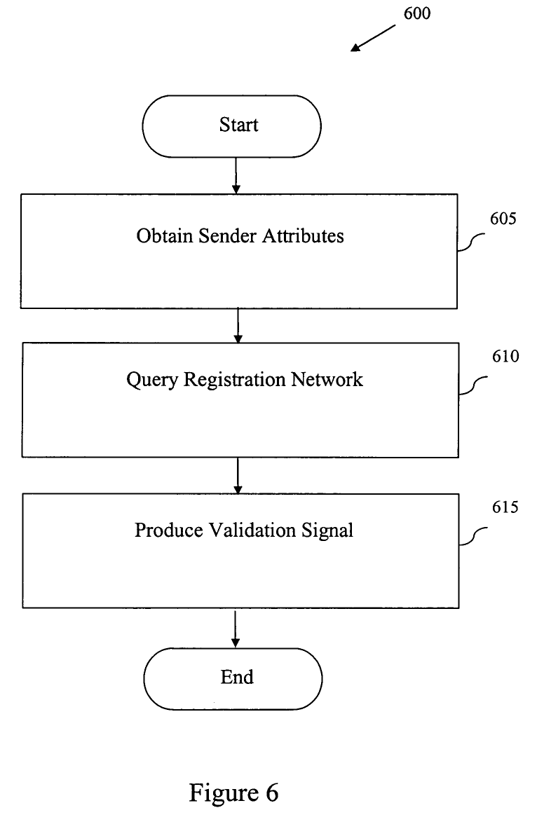

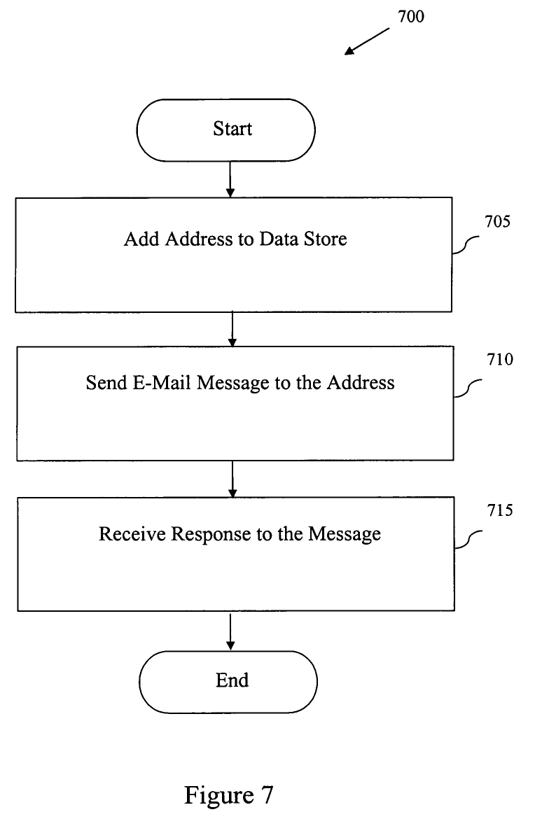

Example methods may be better appreciated with reference to the flow diagrams of FIG. 6 and FIG. 7. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks. While the figures illustrate various actions occurring in serial, it is to be appreciated that various actions could occur concurrently, substantially in parallel, and/or at substantially different points in time.

Illustrated in FIG. 6 is an example methodology 600, that can be associated with a system for validating electronic communications. Illustrated in FIG. 7 is an example methodology 700 that can be associated with preparing a registration network. The illustrated elements denote “processing blocks” that may be implemented in logic. In one example, the processing blocks may represent executable instructions that cause a computer, processor, and/or logic device to respond, to perform an action(s), to change states, and/or to make decisions. Thus, the described methodologies can be implemented as processor executable instructions and/or operations provided by a computer-readable medium. In another example, the processing blocks may represent functions and/or actions performed by functionally equivalent circuits such as an analog circuit, a digital signal processor circuit, an application specific integrated circuit (ASIC), or other logic device. The diagrams of FIG. 6 and FIG. 7, as well as the other illustrated diagrams, are not intended to limit the implementation of the described examples. Rather, the diagrams illustrate functional information one skilled in the art could use to design/fabricate circuits, generate software, or use a combination of hardware and software to perform the illustrated processing.

It will be appreciated that electronic and software applications may involve dynamic and flexible processes such that the illustrated blocks can be performed in other sequences different than the one shown and/or blocks may be combined or separated into multiple components. Blocks may also be performed concurrently, substantially in parallel, and/or at substantially different points in time. They may also be implemented using various programming approaches such as machine language, procedural, object oriented and/or artificial intelligence techniques. The foregoing applies to all methodologies described herein.

FIG. 6 illustrates an example method 600 for validating an electronic communication. The method 600 may include obtaining sender attributes from an electronic communication (block 605). The method 600 may also include querying a data store (block 610). The method 600 may also include producing a validation signal (block 615). The registration network that is queried may be a central database or databases including e-mail addresses. The registration network may be configured to be accessed by multiple sources, by multiple systems that may include a retrieval logic and a validation logic. The multiple sources may be associated with different e-mail servers, for example.

While FIG. 6 illustrates various actions occurring in serial, it is to be appreciated that various actions illustrated in FIG. 6 could occur substantially or partly in parallel.

FIG. 7 illustrates an example method 700 for preparing a registration network. The method 700 may include adding an e-mail message to a data store (block 705). The method 700 may also include sending an e-mail message to the address (block 710). The method 700 may also include receiving a response to the e-mail message (block 715). It should be appreciated that once the method 700 is completed with respect to an e-mail address (e.g., once the e-mail address has been validated), the registration network on which it resides may be accessed by multiple sources, by multiple e-mail servers for example.

While FIG. 7 illustrates various actions occurring in serial, it is to be appreciated that various actions illustrated in FIG. 7 could occur substantially or partly in parallel.

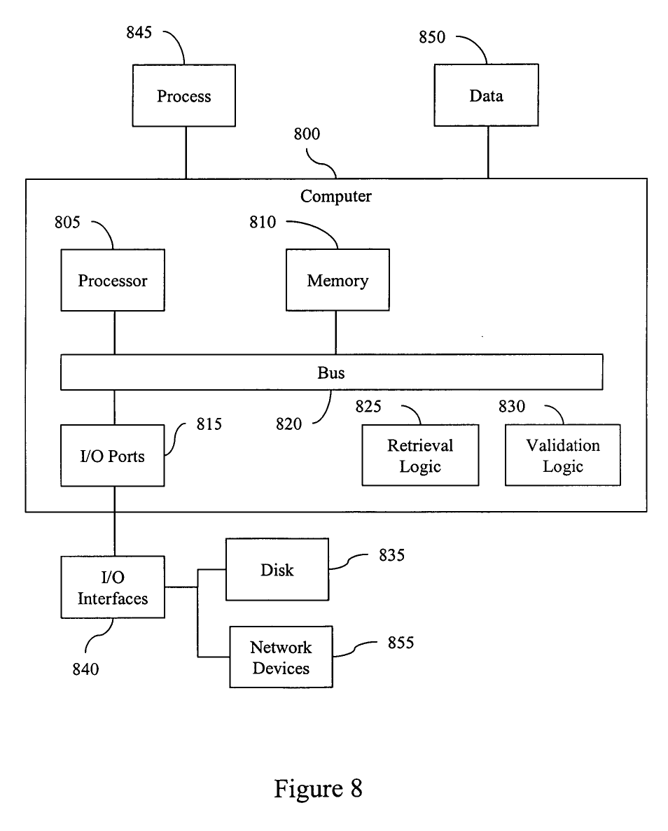

System 100 (FIG. 1) may be associated with and/or embedded in a variety of systems. One such system is a computer. FIG. 8 illustrates a computer 800 that includes a processor 805, a memory 810, and input/output ports 815 operably connected by a bus 820. Executable components of example systems described herein may be located on a computer like computer 800. Similarly, example computer executable methods described herein may be performed on a computer like computer 800. It is to be appreciated that other computers may also be employed with the example systems and methods described herein. The computer 800 may include, for example, an organization logic 825. The organization logic 825 may be configured, for example, to establish relationship data for a plurality of data files. The computer 800 may include, for example, a display logic 830. The display logic 830 may be configured, for example, to visually represent an organization of files and/or subject matter using the relationship data.

The processor 805 can be a variety of various processors including dual microprocessor and other multi-processor architectures. The memory 810 can include volatile memory and/or non-volatile memory. The non-volatile memory can include, but is not limited to, read only memory (ROM), programmable read only memory (PROM), electrically programmable read only memory (EPROM), electrically erasable programmable read only memory (EEPROM), and the like. Volatile memory can include, for example, random access memory (RAM), synchronous RAM (SRAM), dynamic RAM (DRAM), synchronous DRAM (SDRAM), double data rate SDRAM (DDR SDRAM), and direct RAM bus RAM (DRRAM).

A disk 835 may be operably connected to the computer 800 via, for example, an input/output interface 840 and/or an input/output port 815. The disk 835 can include, but is not limited to, devices like a magnetic disk drive, a solid state disk drive, a floppy disk drive, a tape drive, a Zip drive, a flash memory card, and/or a memory stick. Furthermore, the disk 835 can include optical drives like, a compact disc ROM (CD-ROM), a CD recordable drive (CD-R drive), a CD rewriteable drive (CD-RW drive) and/or a digital video ROM drive (DVD ROM). The memory 810 can store processes 845 and/or data 850, for example. The disk 835 and/or memory 710 can store an operating system that controls and allocates resources of the computer 800.

The bus 820 can be a single internal bus interconnect architecture and/or other bus or mesh architectures. The bus 820 can be of a variety of types including, but not limited to, a memory bus or memory controller, a peripheral bus or external bus, a crossbar switch, and/or a local bus. The local bus can be of varieties including, but not limited to, an industrial standard architecture (ISA) bus, a microchannel architecture (MSA) bus, an extended ISA (EISA) bus, a peripheral component interconnect (PCI) bus, a universal serial (USB) bus, and a small computer systems interface (SCSI) bus.

The computer 800 may interact with, for example, i/o interfaces 840 via input/output ports 815. Input/output interfaces 840 can include, but are not limited to, a keyboard, a microphone, a pointing and selection device, cameras, video cards, displays, disk 835, network devices 855, and the like. The input/output ports 815 can include but are not limited to, serial ports, parallel ports, and USB ports.

The computer 800 can operate in a network environment and thus may be connected to network devices 855 via the i/o interfaces 840 and/or the i/o ports 815. Through the network devices 855, the computer 800 may interact with a network. Through the network, the computer 800 may be logically connected to remote computers and communicate with the remote computers. The networks with which the computer 800 may interact include, but are not limited to, a local area network (LAN), a wide area network (WAN), and other networks. One network with which the computer 800 may interact is a registration network, as described herein. The network devices 855 can connect to LAN technologies including, but not limited to, fiber distributed data interface (FDDI), copper distributed data interface (CDDI), Ethernet/IEEE 802.3, token ring/IEEE 802.5, wireless/IEEE 802.11, Bluetooth (IEEE 802.15.1 WPAN (wireless personal area network)), and the like. Similarly, the network devices 855 can connect to WAN technologies including, but not limited to, point to point links, circuit switching networks like integrated services digital networks (ISDN), packet switching networks, and digital subscriber lines (DSL).

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While the present invention has been illustrated by the description of embodiments thereof, and while the embodiments have been described in considerable detail, it is not the intention of the applicants to restrict or in any way limit the scope of the appended claims to such detail. The invention, in its broader aspects, is not limited to the specific details, the representative apparatus, and illustrative examples shown and described. Additional advantages and modifications will readily appear to those skilled in the art. It is intended that the embodiments described herein be construed as including all such alterations and modifications insofar as they come within the scope of the appended claims or the equivalence thereof. Accordingly, departures may be made from such details without departing from the spirit or scope of the applicant's general inventive concept.

1. A system, comprising:
a retrieval logic configured to obtain a sender's e-mail address from an e-mail message sent to a user;
a registration network including a plurality of e-mail addresses that have been registered; and
a validation logic configured to query the registration network with the sender's e-mail address and to produce a validation signal;
where the validation signal provides for transmitting the e-mail to the user if the sender's e-mail address is included in the registration network; and
where a message sent from an e-mail address that has been registered by a first user, can be received by a second user without further registration of the e-mail address by the second user.

2. A registration network, comprising:
an e-mail address that has been registered by a first user;
where a message sent to the first user from the e-mail address that has been registered is receivable by the first user; and
where a message sent to a second user from the e-mail address that has been registered is receivable by the second user.
